(19) United States
(12) Patent Application Publication
(10) Pub. No.: US 2020/0357129 A1
(43) Pub. Date: Nov. 12, 2020

(54) SYSTEMS AND METHODS OF PROXIMITY DETECTION FOR RACK ENCLOSURES

(71) Applicant: SCHNEIDER ELECTRIC IT CORPORATION, West Kingston, RI (US)

(72) Inventors: Stephen Paul Linder, Medford, MA (US); Kesavan Yogeswaran, Somerville, MA (US)

(21) Appl. No.: 16/603,681

(22) PCT Filed: Apr. 18, 2018
(86) PCT No.: PCT/US2018/028153

§ 371 Date: Oct. 8, 2019

Related U.S. Application Data
(60) Provisional application No. 62/487,110, filed on Apr. 19, 2017.

(51) Int. Cl. G06T 7/70; G06T 7/10; G06T 7/00; G06T 5/30; G06T 17/20; H04N 7/18

(52) U.S. Cl. CPC G06T 7/70; G06T 7/10; G06T 7/0002; G06T 2207/30204; G06T 17/205; H04N 7/185; G06T 5/30

(57) ABSTRACT

Systems and methods of proximity detection for a rack enclosure are disclosed. An example system may comprise, extracting, at a processor, a boundary mask image from a captured image, performing, at a processor, image correction operations on the boundary mask image, processing, at a processor, the boundary mask image utilizing image processing operations to determine a corrected boundary mask image, determining, at a processor, a mesh of image segments based on the corrected boundary mask image, establishing, at a processor, one or more baseline image metrics of the mesh of the image segments, evaluating, at a processor, the one or more baseline image metrics for changes with operational image segment characteristics, and communicating, at a processor, any baseline image metric changes to a management device.

### PRIORITY CLAIM

This application claims priority to and benefit from the following provisional patent application: U.S. Provisional Application Ser. No. US 62/487,110 titled “Systems and Methods of Proximity Detection for Rack Enclosures” filed on Apr. 19, 2017. The entire contents of this aforementioned patent application are expressly incorporated by reference herein

### FIELD OF THE INVENTION

Embodiments of the present disclosure relate generally to systems and methods of proximity detection, and more specifically to systems and methods for proximity detection for rack enclosures.

### BACKGROUND

### Description of the Related Art

Rack enclosures and rack enclosure systems are generally used to receive and store electronic equipment and accessories to that equipment. Such enclosures generally contain computer hardware that has great monetary value. Of even greater value however, is the data on this computer hardware and the underlying business processes the computer hardware supports. As a result, security of the computer equipment enclosed within a rack or rack system, is a critical facet of modern business operations.

Security for computer equipment enclosed within a rack or rack system may be accomplished by securing the environment surrounding the rack enclosure or rack system. This environment may be an entire building, wing, room, and/or closet that contains the computer equipment to be secured. Alternatively, various methods may be employed to secure the computer equipment within a rack or rack enclosure itself such as a variety of locking mechanisms. Such methods are effective in maintaining security for environments where the computer equipment is administered by a group that maintains autonomy over the entire environment.

In many environments, colocation of computer equipment from one or more distinct owners may exist. These colocation facilities may be a data center or other facility, where a plurality of businesses or individuals may contract for space and infrastructure services for their computer equipment. In such a colocation scenario, security of computer equipment becomes paramount to avoid any accidental or intentional disruption of service or data theft. Many security measures are either reactive, such as locks, or human resource intensive, such as security escorts when a computer equipment owner physically accesses their own equipment. Maintaining proactive and resource light security methods to protect computer equipment is a serious challenge.

### SUMMARY

Systems and methods of proximity detection for a rack enclosure are disclosed. A system of detecting proximity to a rack enclosure may comprise, extracting, at a processor, a boundary mask image from a captured image, performing, at a processor, image correction operations on the boundary mask image, processing, at a processor, the boundary mask image utilizing image processing operations to determine a corrected boundary mask image, determining, at a processor, a mesh of image segments based on the corrected boundary mask image, establishing, at a processor, one or more baseline image metrics of the mesh of image segments, evaluating, at a processor, the one or more baseline image metrics for changes with operational image segment characteristics, communicating, at a processor, any baseline image metric changes to a management device.

Principles of the disclosure also contemplate the corrected boundary mask image is processed to form a regular tessellation, a semi-regular tessellation, a demi-regular tessellation, and/or a segmented image.

Additionally, systems and methods of a proximity detection for a rack enclosure contemplate if a boundary marker is dynamically shifted in time, a boundary marker comprises one of adhesive tape, infra-red reflective tape, paint, and/or laser markers, and if a boundary marker comprises removable objects.

Further, a system of detecting proximity to a rack enclosure may comprise one or more rack enclosures, one or more visible boundary markers, one or more video camera configured to capture and transmit image data, a Video Image Processing Module (VIPMs) configured to receive and process image data from the video camera and communicate image data changes; and a management device configured to receive image data changes.

### BRIEF DESCRIPTION OF THE DRAWINGS

These accompanying drawings are not intended to be drawn to scale. In the drawings, each identical or nearly identical component that is illustrated in various figures is represented by a line numeral. For purposes of clarity, not every component may be labeled in every drawing. In the drawings:

FIG. 1 illustrates aspects of a rack enclosure proximity detection system in accordance with various embodiments of this disclosure;

FIG. 2 illustrates aspects of a rack enclosure proximity detection system for various rack enclosure types in accordance with various embodiments of this disclosure;

FIG. 3A illustrates aspects of a rack enclosure proximity detection system utilizing a boundary marker in accordance with various embodiments of this disclosure;

FIG. 3B illustrates aspects of a rack enclosure proximity detection system utilizing a plurality of boundary markers in accordance with various embodiments of this disclosure;

FIG. 4A illustrates aspects of boundary marker image segments of a regular tessellation and detection in accordance with various embodiments of this disclosure;

FIG. 4B illustrates alternate embodiments of boundary marker image segments of a semi-regular tessellation and detection in accordance with various embodiments of this disclosure;

FIG. 4C illustrates alternate embodiments of boundary marker image segments of a demi-regular tessellation and detection in accordance with various embodiments of this disclosure;

FIG. 4D illustrates alternate embodiments of boundary marker image segments of a tessellation and detection in accordance with various embodiments of this disclosure;

FIG. 4E illustrates alternate embodiments of boundary marker image segments that are non-uniform in size in accordance with various embodiments of this disclosure;

FIG. 4F illustrates alternate embodiments of boundary marker image segments that do not overlap in size in accordance with various embodiments of this disclosure;

FIG. 5 illustrates a system diagram of a Video Image Processing Module (VIPM) detailing for a rack enclosure proximity detection system in accordance with various embodiments of this disclosure;

FIG. 6A illustrates a flow diagram detailing a baseline image segmentation and calibration process for a rack enclosure proximity detection system in accordance with various embodiments of this disclosure;

FIG. 6B illustrates a flow diagram detailing a baseline image segment correction process for a rack enclosure proximity detection system continued from FIG. 6A;

FIG. 6C illustrates a flow diagram detailing an image segment detection process for a rack enclosure proximity detection system continued from FIG. 6B;

FIG. 7 illustrates examples of a rack enclosure proximity detection system comprising a single camera and boundary and boundary marker in accordance with various embodiments of this disclosure;

FIG. 8 illustrates alternate embodiments of a rack enclosure proximity detection system comprising a plurality of cameras and boundary markers in accordance with various embodiments of this disclosure;

FIG. 9 illustrates a functional block diagram of a general-purpose computer system in accordance with various embodiments of this disclosure; and

FIG. 10 illustrates a functional block diagram of a general-purpose storage system in accordance with the general-purpose computer system illustrated in FIG. 9.

### DETAILED DESCRIPTION

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for description purposes and should not be regarded as limiting. The use of “including,” “comprising,” “having,” “containing,” “involving,” and variations herein, are meant to be open-ended, i.e. “including but not limited to.”

Computer equipment and related devices are generally located within a rack system. In additional to the infrastructure support system of power and cooling for the computer equipment, security of both the computer equipment and data it is responsible for storing, processing, and/or transacting is highly beneficial. While security in the form of physical and/or virtual barriers and/or personnel may be effective for facilities with dedicated computer equipment for a single party, comingling of computer equipment with various ownership frequently occurs at colocation facilities.

Colocation centers generally, are a form of data center where computer equipment, space, and infrastructure such as power, cooling, and security, are available for rental to retail, commercial, other entities. Such a space is generally available to a variety of customers with computer equipment. It is highly desirable to maintain security for an entity's equipment to prevent computer equipment and/or data from that computer equipment being accessed accidentally or intentionally from an unauthorized party.

Limiting access to a room or particular rack enclosures utilizing video surveillance or security escorts to allow access to authorized equipment are example methods of security. These methods while effective can be resource intensive and require an individual to monitor a camera or provide an escort. Escorts into colocations may be preferred so any attempt to gain unauthorized access can be stopped immediately but are also resource intensive.

To address the problems of resource allocation, monitoring an environment, and immediate detection and notification of a potential or actual unauthorized access, autonomous detection system of a person and/or an object crossing one or more boundaries may be utilized as described in this disclosure. A detectable boundary may be placed on a floor or other surface around and/or proximate to a rack system. This boundary may give a visual marker to individuals in the vicinity while also serving as a component for a computer vision solution. If the boundary is breached, an alert/notification may be generated and sent to appropriate security personnel or other actions may be initiated such as a power down of equipment or security lock down of the facility.

Advantages of the various embodiments contained herein include; an ability to process video images robustly yet with a minimum of computational processing power, reduced cost of system hardware, and faster processing speeds without sacrificing image quality using parallel processing. In concert and individually, the systems described herein facilitate these advantages and enable powerful methods for rack proximity breach detection at a low cost. This trade-off of creating a low-end video detection system with selectively parallel processing discrete portions of a captured video image to determine if a boundary in three-dimensional space has been breached is a significant advantage over existing video processing systems.

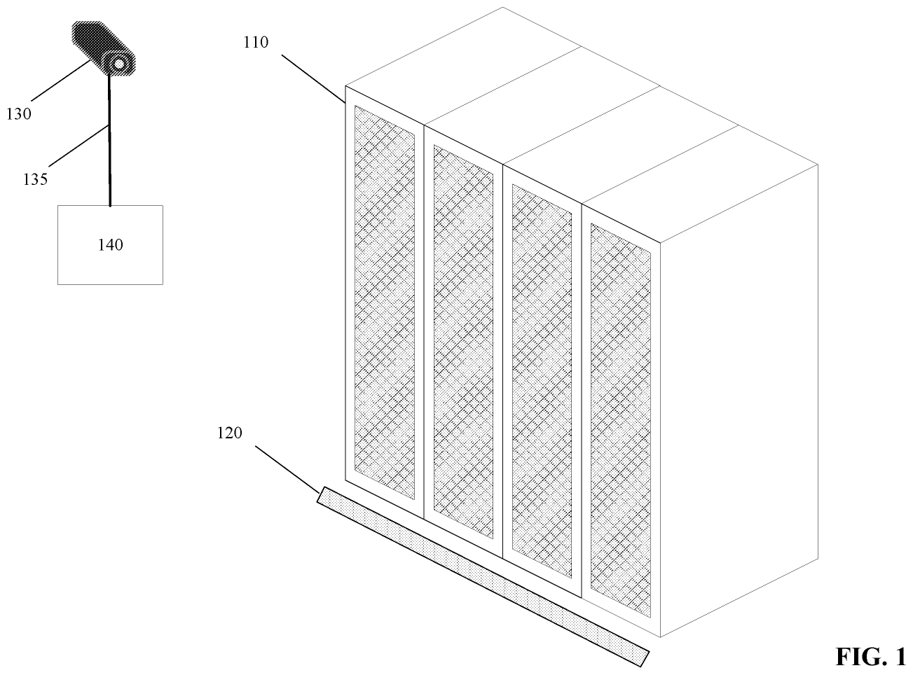

FIG. 1 illustrates aspects of a rack enclosure proximity detection system in accordance with various embodiments of this disclosure. One embodiment of a rack enclosure proximity detection system may include one or more rack enclosures 110, one or more visible boundary markers 120, one or more video cameras 130, and a Video Image Processing Module (VIPM) 140, connected by a data and/or power connection 135, such as Power Over Ethernet (POE) or other data only standard, wired or wireless in nature. Embodiments of the system may also include one or more computer systems (not shown) to assist in facilitating the benefits of the disclosure such as communication to one or more management devices.

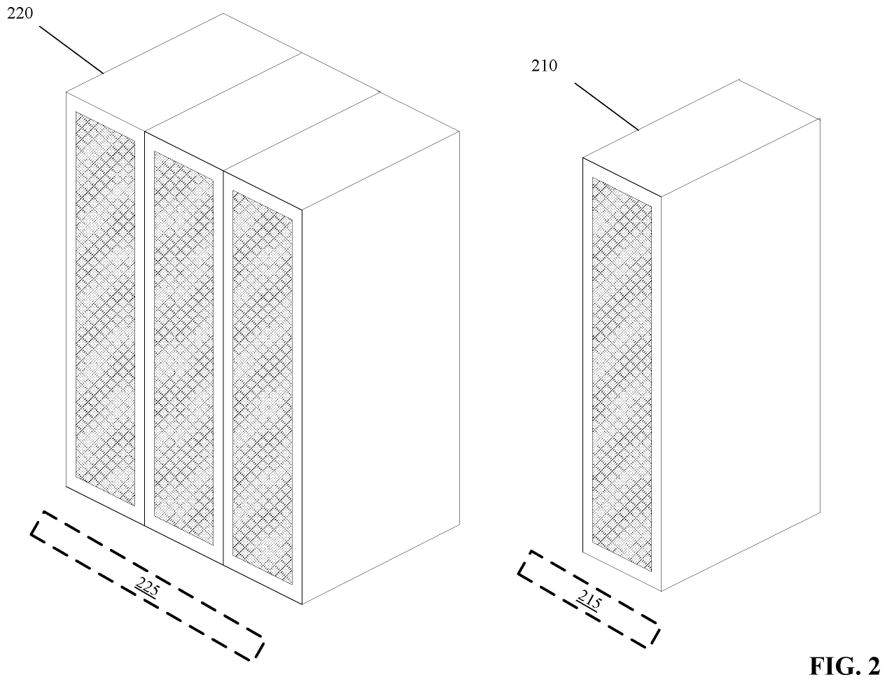

FIG. 2 illustrates aspects of a rack enclosure proximity detection system for various rack enclosure types in accordance with various embodiments of this disclosure. Various embodiments of a rack enclosure may be utilized in the system including a single rack enclosure 210, a plurality of rack enclosures 220, or other enclosures to store computer equipment.

In contrast to FIG. 1, where the boundary marker 120 is visible and used throughout both system commissioning and detection operations, FIG. 2 utilizes a visible boundary marker 120 during the system commissioning and non-visible boundary markers 215, 225 after the system commissioning is completed, any baseline image correction is performed, and image segment detection processes are underway.

Principles of the disclosure contemplate rack enclosures which are adjacent with each other such as various data center or colocation environments but also rack enclosures that are physically separate and apart from one another. Also contemplated are structures that may not house computer equipment but are adjacent to and/or associated with rack enclosures which do. Examples of such structures may be, but are not limited to, cable support structures, power and cooling duct and support structures, and/or infrastructure equipment to support the computer equipment such as power distribution and associated equipment.

It should be appreciated, while rack enclosures may be composed in various manners to accommodate the computer equipment it is designed to house, this disclosure contemplates autonomous proximity detection absent a rack enclosure. Any enclosure, or other space may utilize embodiments of this system to autonomously detect an unauthorized breach or access of a system secured space. Further it is to be understood, that the secured space may be multi-dimensional, such as a two-dimensional surface or three-dimensional space, based on a variety of factors including, the application, asset(s) to be secured, and/or the particular system implementation.

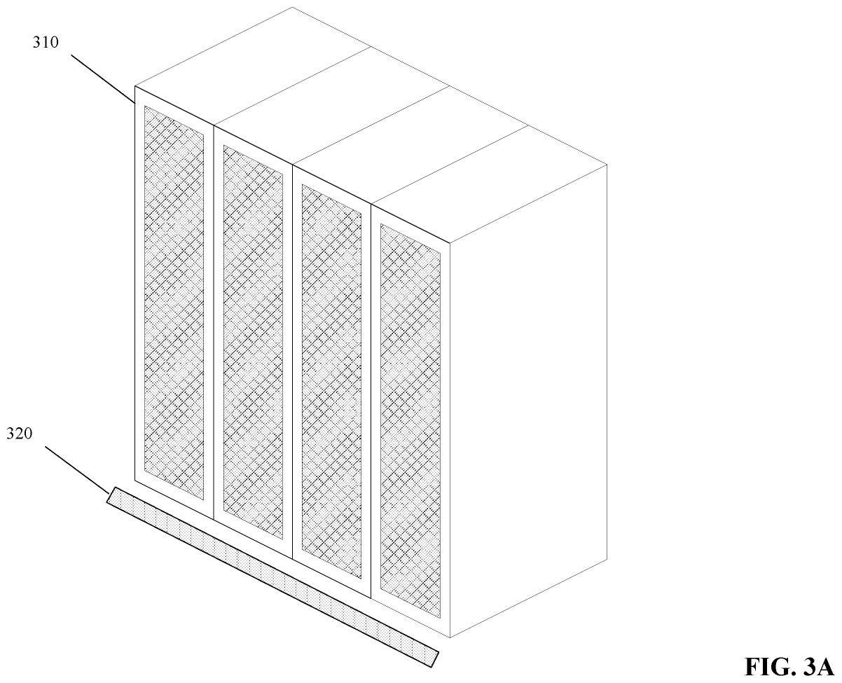

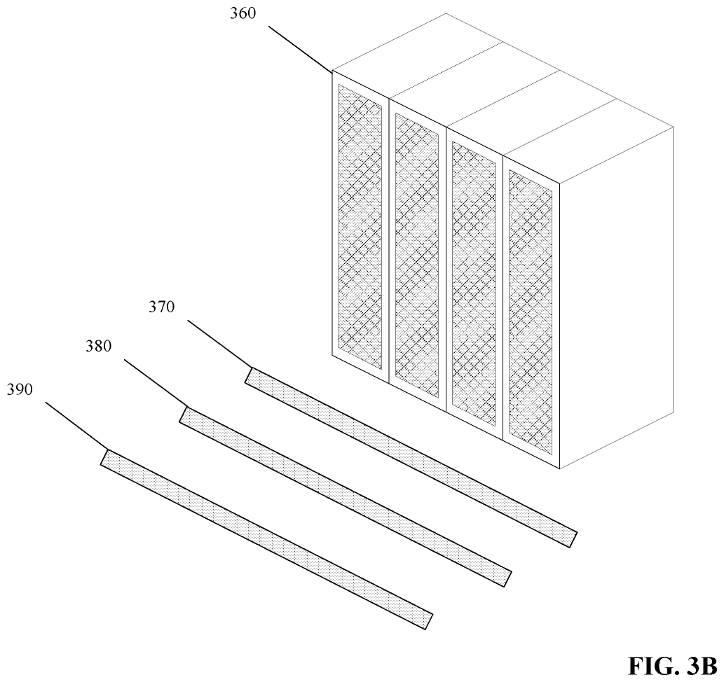

FIG. 3A illustrates aspects of a rack enclosure proximity detection system utilizing a boundary marker 320 in accordance with various embodiments of this disclosure. In this embodiment, a plurality of rack enclosures 310 has a corresponding boundary marker 320. Proximity breach detection establishes an image from a security camera and a boundary marker 320 where proximity breach detection is to be monitored. In these implementations, the system can effectively provide a three-dimensional secured space around one or more assets based in part on where the boundary marker is strategically situated.

A boundary marker 320 initially defines a contrast to the background on which it is placed to facilitate system commissioning in developing a baseline detection image. In some embodiments, the boundary marker 320 is maintained in place during image detection operations. In other embodiments, the boundary marker 320 is removed when commissioning is completed and the baseline image is created. The VIPM utilizes such contrast to create a baseline image. This baseline image is utilized in a comparison to an operational image acquired post system commissioning. Pixels of the operational image or pixels in at least one segment of the operational image are compared to pixels of the baseline image or pixels in at least one segment of the baseline image of the boundary marker 320. If the comparison of images identifies pixel changes in the boundary/secured area, the space surrounding the secured asset has been breached.

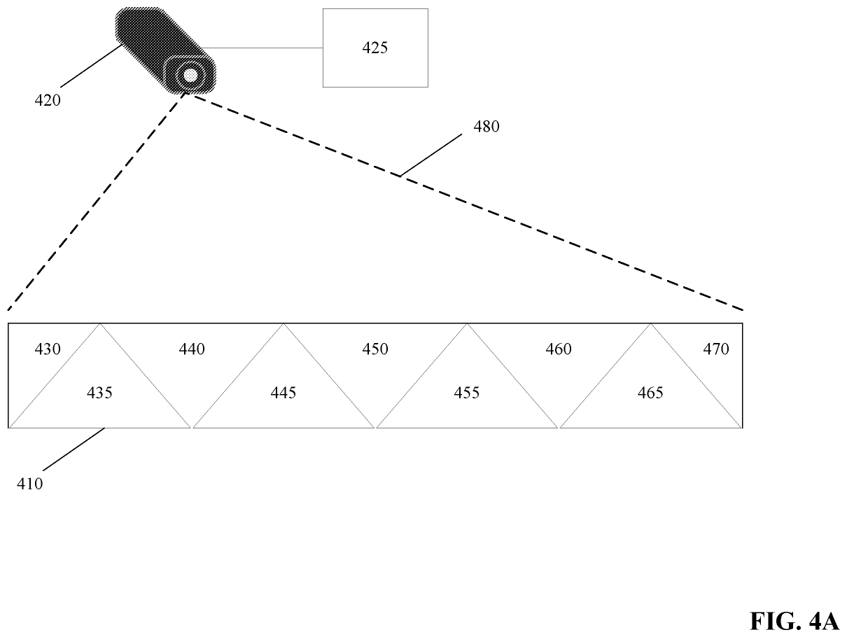

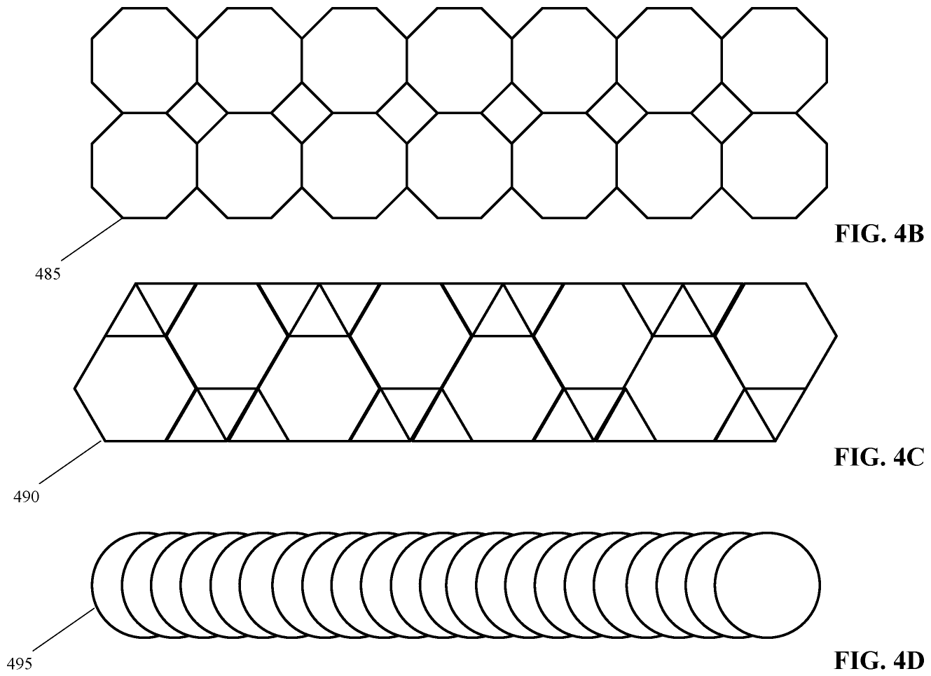

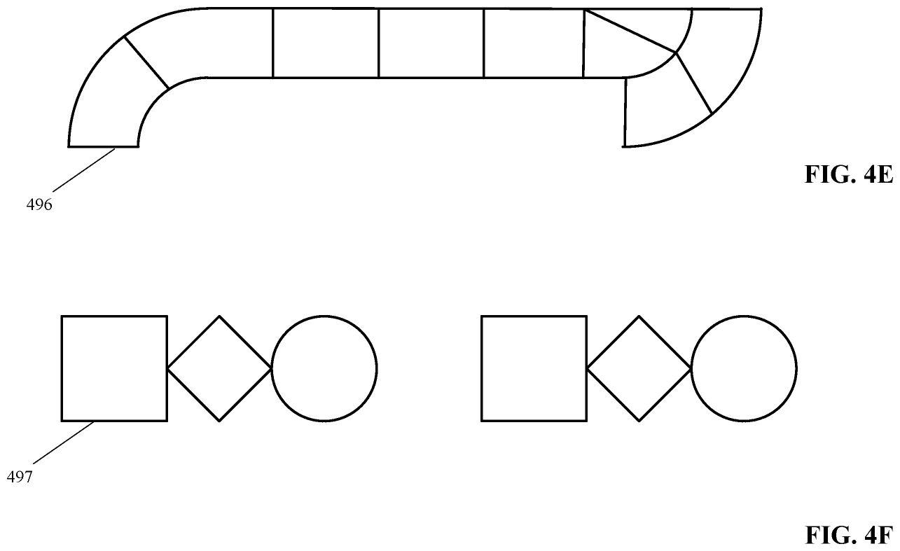

Examples of contrast to the background which may be implemented include, detecting contrast of the matte color, reflectance characteristics for Infra-Red (IR) and/or visual light, and/or illumination level. It should be appreciated this list is not exhaustive and other embodiments of contrast and contrast levels are possible. Aspects of image processing associated with breach detection will be described in more detail in FIGS. 4A-6C.

As one of many examples, the boundary marker 320 may be composed of adhesive tape which is placed at one or more strategic locations for use both as a visual guide to users and to facilitate creation of the boundary marker 320 used to generate the baseline image used by the system during commissioning. The boundary marker 320 contrasts with the floor or other surface which surrounds the boundary marker 320 and be utilized by the VIPM to calibrate and determine a baseline image for comparison during image breach detection operations. Once the calibration is complete, the boundary marker 320 may remain in place and function both as a visual marker for users and as part of the baseline for the system to compare operational images against. Although illustrated as a marker applied to the floor of a data center, it is to be understood other boundary marker applications are possible for example, on walls, ceilings, cabinets, and/or other structures situated near or around the one or more assets and/or space to be secured.

A boundary marker 320 may consist of media which provides a contrast to the surrounding environment. Examples of such media may include, but are not limited to, paint, adhesive tape with a uniform or patterned surface such as stripes, free standing markers such as traffic cones, and/or laser markers. It should be appreciated the boundary marker 320 need not be static in nature and may change with time or other event, or series of events. For example, a system may be configured to change the method of detection, either periodically such as every hour, minute, day, week, or with a pre-defined triggering event, combination and/or series of triggering events. An example of a triggering event may be activation of a door sensor, security alarm, or audible alert sensor, such as a glass break monitor.

In an implementation, a dynamic laser line may be established by a user at a predetermined time interval to act as boundary marker 320 around one or more assets and/or within a space desired to be secured. Once this dynamic boundary marker 320 is calibrated, and as necessary, corrected, the system will begin detection operations. Once the dynamic boundary marker 320 is moved at the expiration of the predetermined time interval and/or triggering event, the system will recalibrate to the new location of the dynamic boundary marker 320 and reinitiate image detection operations in the new boundary marker 320 location.

It should also be appreciated that the dimensions of the one or more implemented boundary markers may be based on the operational environment and/or the secured asset(s) characteristics. No fixed dimensions are required to establish an effective boundary marker 320. A determinative aspect of a boundary marker 320 is that it may be detected by the VIPM during calibration. Once the system is calibrated and corrected as necessary, the boundary marker 320 may remain in situ or be removed for image detection operations. Depending on the implementation, a single boundary marker 320 may be used or more than one boundary marker may be used in coordination with each other to secure assets as illustrated in FIG. 3B.

Some embodiments contemplate the boundary marker 320 may be removed after being recognized and calibrated by the proximity detection system described herein. In such embodiments, while boundary markers are placed initially, they may be removed after commissioning to create an “invisible boundary” which remains detectable to the proximity detection system.

FIG. 3B illustrates aspects of a rack enclosure proximity detection system utilizing a plurality of boundary markers in accordance with various embodiments of this disclosure. In one embodiment, a plurality of rack enclosures 360 is demarked by an inner boundary marker 370, a middle boundary marker 380, and an outer boundary marker 390. Each boundary marker may act independently or in coordination with the other and may serve as tiers of security.

In an embodiment, the outermost marker represents a first in increasing levels of security and the innermost marker representing the most severe security condition. It should be appreciated the relative distance between the plurality of markers may vary depending on a variety of operational and/or environmental factors. There is no need for the markers to be in proximity of each other as illustrated in FIG. 3B. Further, while three boundary markers are illustrated, there is no constraint to the number of boundary markers the system may utilize. It should also be appreciated that while FIG. 3B illustrates visible boundary markers, one, some, or all the boundary markers may be removed once calibrated and corrected as necessary, for the image detection operation of the system.

As one of many examples, if proximity breach is determined at the outer boundary marker 390, the system may be configured to generate and transmit text messages to specified personnel. The system may also initiate, for example, an increased video frame rate or increased image resolution, to allow more granular video data of a higher quality to be captured. If the middle boundary marker is breached, the system may also include initiation of an audible alarm. In one implementation, if the inner boundary marker is breached, which may signify the most serious security condition, the computer equipment within the rack enclosures may be powered down to cause the computer equipment to be unusable.

Actions may be correlated to each boundary marker in any order. Other actions depending on the particular implementation are possible in various sequences to create the desired security configuration for the rack enclosure, two-dimensional surface, or three-dimensional space, to be monitored. As one of many examples, timing between breach detection of boundaries may be utilized as one factor to determine what actions to take. If some individual breaches the outer boundary marker 390 an audible warning would occur. Further, a timer may be set where if a breach of the middle boundary 380 were to occur within a specified period of time (e.g. 5 seconds) of the breach of the outer boundary 390, any breach of the inner boundary 370 would result in an immediate shutdown to the computer equipment in the rack enclosure 360. However, if a longer interval than programed occurs (e.g. more than 5 seconds), other actions may be taken, such as a text message warning appropriate personnel of the security alert.

To realize the benefit of utilizing low end video detection systems, various methods may be utilized for video processing boundary marker analysis to reduce the amount of processing power necessary to analyze a video image. One example implementation of processor reduction utilizes a segmentation of a captured image. Such a segmentation may take the form of a tessellation, or tiling process. Tessellation renders the selectively detected image of the boundary marker into an arrangement of shapes closely fitting together. FIG. 4A illustrates a regular tessellation and detection method in accordance with various embodiments of this disclosure. Components of the VIPM to detect rack system proximity may include a boundary marker 410, a low-end video camera 420, and a VIPM 425.

Various advantages of the system described herein include cost effective hardware component designs and very fast processing times. Creating a low-end video detection system with selectively parallel processing discrete portions, such as segments, pixels, and/or pixels of particular image segments, of a captured video image to determine if a boundary in three-dimensional space has been breached, is a significant advantage over existing video processing systems. These advantages may be realized in part due to the segmentation, tessellation or tiling process of a boundary marker 410.

The VIPM implements the segmentation/tessellation process, renders the boundary marker 410 into a series of geometric segments. Each individual segment is in turn processed, in series or in parallel, and not the image of the whole boundary marker 410 and surrounding environment. Depending on the amount of changes within the image segment the need for processing power may be reduced. Further utilization of smaller processing elements may be accomplished. Relying on the parallel process of smaller, segment(s) of an image, and/or pixels within an image segment, reduces the amount of processing time substantially as opposed to processing a complete boundary marker 410 image and the surrounding environment, which itself may be very large, or of an irregular shape.

A complete image of a boundary marker 410 and surrounding environment and comparison to an operational image of that boundary marker and surrounding environment, presents a large technical challenge due to the complexity of observing and rendering any image of a boundary marker 410. Embodiments of the disclosure, utilizing boundary marker 410 image segments, and/or pixels of image segments, definition, calibration, and comparison processes, create smaller, less complex VIPM processing requirements.

As a result of these less complex calculations to be performed by the VIPM, the video camera 420 utilized may have a wide range of frame rate and image resolution. An inexpensive video or web camera 420 with entry level characteristics may be utilized for robust proximity detection within embodiments of the disclosure. It should be appreciated a low-end video camera 420 may define various characteristics known to video cameras such as image resolution, frame rate, image stabilization, and/or sensitivity in various light conditions. As one example, a video camera with a video capture resolution of 320×240 pixels, operating at 30 frames per second, without image stability nor low light sensitivity may be utilized in some embodiments of the disclosed system to robustly detect proximity.

As a second example, multiple video cameras may be utilized with dynamic image resolution. Each camera may normally operate at a low image resolution (e.g. 320×240 pixels) may be utilized at 30 frames per second. When a possible intrusion is detected by one camera, resolution of just that camera may increase in resolution, frame rate, and/or other camera characteristics to capture the event. This may, for example, have a benefit of minimizing any congestion for a communications port where multiple cameras may be connected and scanning at a high rate, simultaneously.

It should be appreciated, a video camera 420 with substantially improved characteristics such as 4K resolution, operating at 240 frames per second, with image stability and night vision capabilities may also be utilized in some embodiments of the disclosed system, however may correlate to substantially increased costs for some applications.

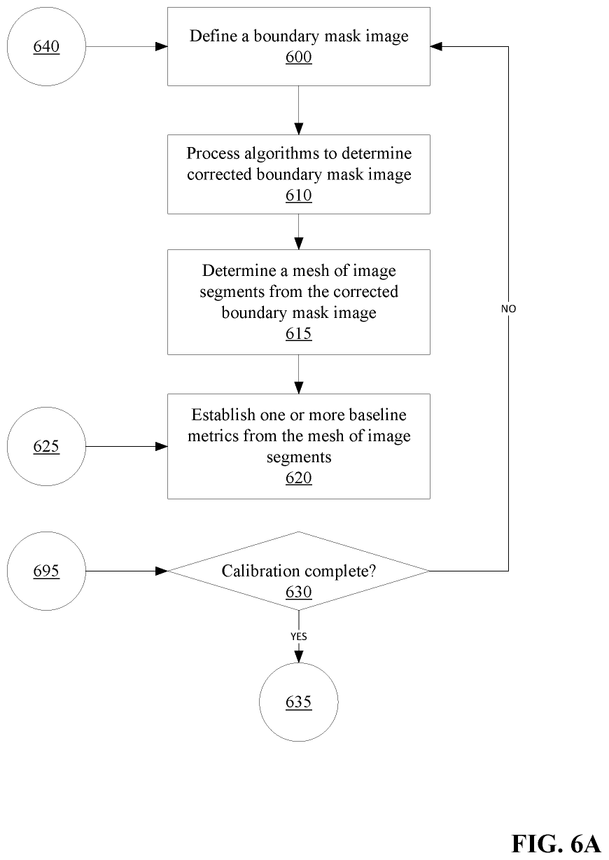

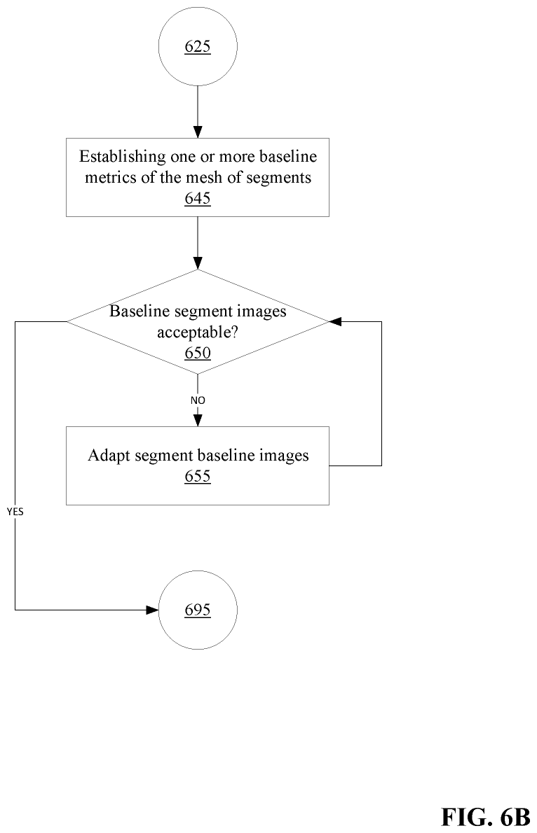

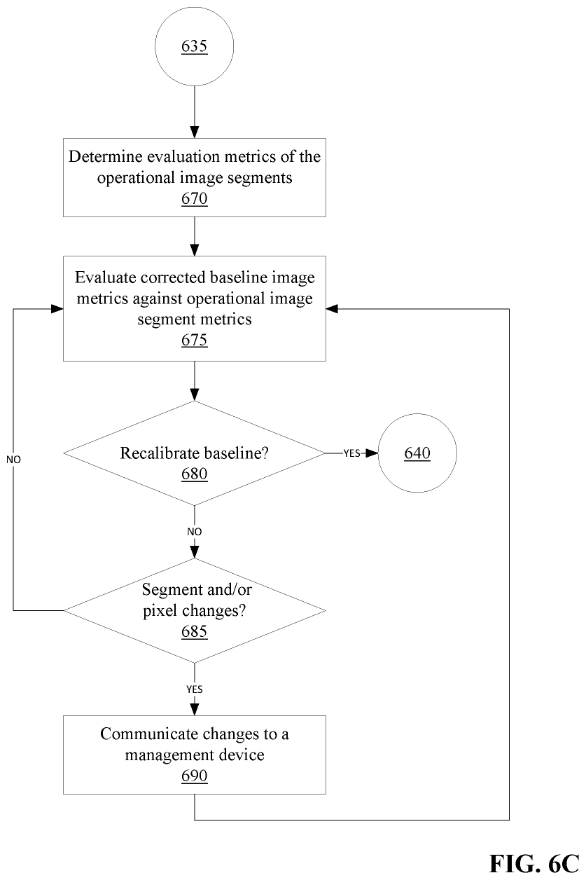

Embodiments of the disclosure discuss aspects of very fast processing times for a boundary marker 410 as a result in part of various embodiments of segmenting the captured image. Embodiments of this segmentation process include the tessellation process. A reduction of processing times is accomplished through the example processes described in FIG. 6A-C. As part of the process, each image of the boundary marker 410 undergoes a segmentation process, such as tessellation, whereby the boundary marker 410 is rendered into an arrangement of image segments. In the case of tessellation, these shapes, may be regular, semi-regular, demi-regular, and may fit together without gaps between spaces. Other embodiments include segmentation, where the image segments need not fit together or be regular, semi-regular, and/or demi-regular in shape.

FIG. 4A illustrates a boundary marker 410 which has been deconstructed via the tessellation process, into a plurality of segments 430, 435, 440, 445, 450, 455, 460, 465, 470. While segments may be triangular as illustrated in FIG. 4A, many variations of shapes are possible including triangles, squares, and hexagons for a regular tessellation. Examples of semi-regular tessellations 485 are illustrated in FIG. 4B, demi-regular tessellations 490 in FIG. 4C, and other boundary marker tessellations 495 in FIG. 4D. Other tessellations types may produce other segment shapes including, but not limited to, circles, ellipses, and other curved shapes. A complete boundary marker 410 need not be formed by straight lines, but may be curved as well.

The type of tessellation may depend on the boundary marker 410 to be segmented. For example, a regular tessellation requires a single identical polygon to form the segments such as the triangle segments in the boundary marker 410 illustrated in FIG. 4A. Other boundary marker shapes may require alternate tessellation types or be of such a shape that no tessellation is possible, only segmentation.

Embodiments of the system also contemplate other methods of segmentation of a boundary marker image in addition to the tessellation process described above. A result of such segmentation may result in a set of image segments which collectively cover the entire boundary marker image. It should be appreciated these image segments may not be uniform in size or may not overlap with each other. FIG. 4E illustrates alternate embodiments of boundary marker image segments that are non-uniform 496 in size and FIG. 4F illustrates alternate embodiments of boundary marker image segments that do not overlap 497 in accordance with various embodiments of this disclosure.

Characteristics of each image segment may or may not contain similar characteristics such as, but not limited to, number of pixels, color, and/or texture. Images may be segmented in a variety of methods including, but not limited to, thresholding, clustering, dual clustering, compression, histogram, edge, and/or region-growing methods.

It should be appreciated that only the portions of the boundary marker 410 which are within the camera field of view 480 may be analyzed by that camera. Embodiments of the disclosure contemplate a plurality of cameras and/or a plurality of boundary markers which may be used in the system to detect proximity in a large area, non-adjacent areas of a space to be secured, and/or to provide redundancy to an area already secured with the disclosed system.

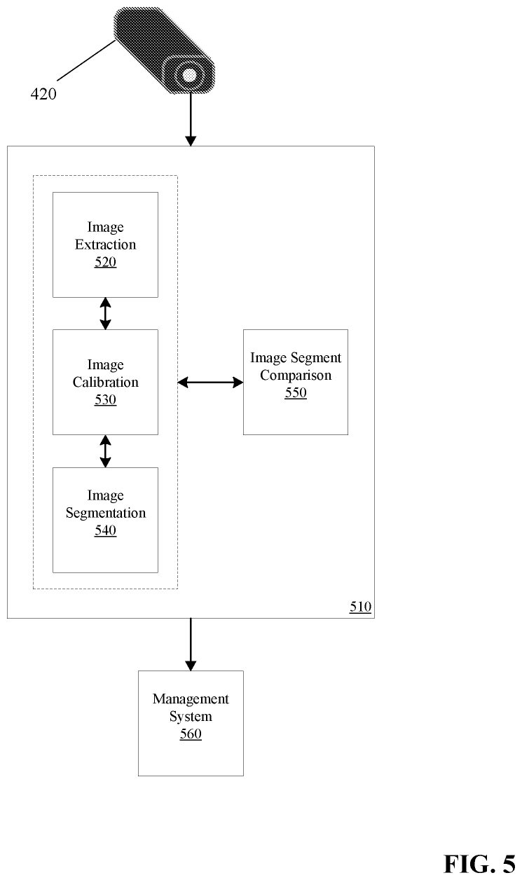

FIG. 5 illustrates a system diagram of a Video Image Processing Module (VIPM) 510 for a rack enclosure proximity detection system in accordance with various embodiments of this disclosure. A VIPM 510 may have inputs, such as a source of video from one or more cameras 420, and/or outputs that may include a management system 560 to further process any information which comes from the VIPM 510.

A VIPM 510 may consist of several sub-modules. These modules may include an image extraction module 520, image and/or image segmentation calibration/correction module 530, image segmentation module 540, and/or an image segment comparison module 550. Image extraction, calibration/correction, and segmentation, may be grouped together logically to provide image and/or image segment refinement for use before and/or after the breach detection operations contemplated in the image segment comparison module 550.

FIGS. 6A-C illustrate examples of flow diagrams of a rack enclosure proximity detection system in accordance with various embodiments of this disclosure. These methods include a video image processing module baseline image segment capture and calibration, baseline image segment correction, and image segment breach detection processing and logic flow. One example of this process may operate in two processing loops. A first process loop may capture, calibrate, and refine baseline image segments marked by a boundary marker or other temporary mark, which may be removed to create an invisible boundary. A second process loop may detect changes to the baseline image segments by comparing the calibrated and/or corrected baseline image segments to one or more operational image segments. It should be appreciated various embodiments of process flows exist.

FIG. 6A illustrates flow diagram detailing aspects of a VIPM implementation baseline image segmentation and calibration process for a rack enclosure proximity breach detection system in accordance with various embodiments of this disclosure. Calibration of the rack enclosure proximity breach detection system is performed on a boundary marker and surrounding environment to create and calibrate baseline image segments. Such calibration may occur one time in a given environment, or may occur several times due to an environment change, such as changes in ambient light levels during the course of a day. Once a boundary marker 410 is placed, it must be located within the field of view of a video camera 420 and the entire VIPM system calibrated to determine where the boundary marker is located, characteristics of the boundary marker image, and/or capturing of a baseline image segments of the boundary marker for use during the image breach detection phase of the system.

A boundary mask image is defined 600 where images of the boundary marker 410 are captured and processed to define an image mask of the boundary marker 410 for the baseline image. Logical and numerical operators isolate the image of the boundary marker 410 from the surrounding environment based on the contrast of the boundary marker 410. Such operators may be applied on a pixel by pixel basis. Examples of such operations may include subtracting, averaging, logical NOT, AND, and/or OR. This VIPM image isolation defines the boundary mask image characteristics and process the image properties of the boundary marker 410. Image properties of the boundary mask image may include hue, saturations, and/or brightness that allow the system to distinguish the boundary mask image from the remainder of the captured image. When complete, the boundary mask may consist of an outline image of the boundary marker.

Once the boundary mask image is defined 600, it may be necessary for the VIPM to capture, correct, and/or validate the boundary mask image 610. Image correction may be accomplished in a variety of ways. These may include, a series of morphological operations performed on the boundary mask image. Such morphological operations utilize a collection of non-linear functions related to the shape or morphology of features in an image which may be utilized to determine an edge, remove noise, enhance, and/or segment an image. Examples of these operations include erosion and/or dilation.

Erosion is a process which removes image pixels and is used for example, to split joined objects which should not be joined within an image and/or to strip extrusions from an image. This process erodes away boundaries of pixels in foreground regions of an image by performing arithmetic operations on a captured image and a structuring element, or kernel.

Dilation is a process which adds image pixels and is used for example, to repair breaks in an image and/or to repair intrusions to an image. This process adds pixels to boundaries in foreground regions by performing arithmetic operations on a captured image and a structuring element, or kernel.

Embodiments process the boundary mask image executed by the VIPM with morphological operations to fill and/or remove non-uniformities in the image of the boundary mask, such as gaps or removal of small image artifacts.

As one example, noise present during the creation of the boundary mask image, may have small imperfections which may or may not be part of the boundary mask image. Such artifacts may potentially confuse the algorithms utilized on the boundary mask image. Image correction operations to reduce and/or remove non-uniformities suck as “speckling” within the boundary mask image allow the removal or reduction of such artifacts.

It should be appreciated; various algorithm types are utilized to correct a boundary mask image 610. Such algorithms may include, but are not limited to contour-finding algorithms. In various embodiments, the boundary marker will appear as a continuous block of pixels in the boundary mask image. This block of pixels may result in the definition of the corrected boundary mask image 610 from the boundary mask image.

In various embodiments, contour finding algorithms are utilized to find contiguous blocks of pixels within the boundary mask image to determine which contours belong to the boundary mask image and which do not. This calibration process assists in identification and creation of an image representation of the boundary marker 410 or another mark.

Once a corrected boundary mask image is determined, the VIPM defines a series of image segments from the corrected boundary mask image 615 utilizing the segmentation, tessellation and/or other process defined in FIGS. 4A-F. A resulting series of image segments of the boundary marker image is defined. These image segments may be processed together, individually, serially, and/or in parallel to reduce the amount of overall processing overhead necessary in the system. Embodiments contemplate processing may occur on an image by image basis, image segment by image segment basis, pixel by pixel basis, and/or contour by contour basis.

In one example, the VIPM may implement a Delaunay triangulation to process the corrected boundary mask image. This triangulation will create a triangular mesh of image segments as illustrated in FIG. 4A. Image processing calculations performed during the detection may be reduced significantly as a result of processing the individual boundary marker image segments or pixels instead of the entire boundary marker 410. Once a mesh of image segments 615 is defined, a segmented baseline image is established 620 which may be used for future image processing.

This established baseline segmented image 620 may require further processing and/or correction to refine the image to be utilized during the image breach detection process. It should be appreciated this processing and/or correction may occur on an image by image basis, a segment by segment basis, pixel by pixel basis, and/or contour by contour basis. FIG. 6B illustrates embodiments of a flow diagram for baseline image segment correction of a rack enclosure proximity detection system. A baseline image segment being established 620 transitions to the baseline correction flow 625 where one or more established baseline image segment(s) are characterized 645. Such characteristics of the one or more baseline image segment(s) may include hue, color saturation, and/or blurring. Other characteristics are contemplated in embodiments of this disclosure. The characteristics may be used as part of the calibration process for the one or more baseline image segment(s) and/or during the breach detection process to compare to an operational image segment and/or to determine when a recalibration of the baseline image segments may be desired.

Once the baseline image segments are characterized 645, a determination may be made if the existing baseline image segments are acceptable 650 for use as a baseline image segment during detection operations. Acceptability metrics may be established utilizing baseline image segment characteristics 645. For example, a determination of baseline acceptability 650 may be determined by an amount of image noise within the baseline image segment. It should also be appreciated that combinations of acceptable metrics may be utilized such as incomplete line segments, irregular contours, and/or adjustments to the environment such as automatic white balancing and/or contrast enhancement, in a determination of acceptability for a baseline image segment.

If it is determined the baseline is not acceptable, correction and/or adaptation of the baseline image segment 655 occurs to correct or adapt the deficiencies to the existing environment. These corrections/adaptations and may repeat until the baseline is determined acceptable, or until such time as the system determines another function, such as aborting the operation and/or utilizing the best available captured baseline. Several alternate functions are contemplated as part of this disclosure, such as time outs, user intervention, and/or external triggering events. Any deficiencies in the baseline image may be remedied utilizing methods detailed herein such as morphological, contour forming, and/or other video processing methods available.

Once the baseline is determined acceptable 650, a determination is made if a user will utilize a visible boundary marker, an invisible boundary, or combination of visible and invisible as discussed above and illustrated in FIG. 2.

If a user or system determines a boundary marker will remain visible and unchanged during detection operations, as is necessary throughout the baseline image calibration process, and the baseline image is determined acceptable 650, the VIPM transitions back to the calibration logic flow 695 and a determination is made if the calibration is complete 630. If calibration is determined to be completed by a user or system, the VIPM transitions to the breach detection operation 635 illustrated in FIG. 6C.

If a user or system determines a boundary marker will be invisible during detection operations, the VIPM may utilize a non-visible marker mode. A user will remove or change the visible boundary marker and the VIPM must adapt and recalibrate the baseline image 655 to adjust for the change in environment. Principles of the disclosure contemplate while the visual boundary marker is removed, the system retains the location of the boundary marker segments and calculates a baseline for the boundary marker segments with the new background, or no visible boundary marker. This boundary marker image is utilized to derive a new baseline image, along with existing images of the field of view to adjust for the surrounding environment. Image properties of the new baseline image are adapted/calibrated from the new environment of no visible boundary marker. If the new baseline image is acceptable 650, the process transitions back to the calibration logic flow 695 and a determination is made if the calibration is complete 630. If the calibration is determined to be completed 630, the system transitions to the detection operation 635 illustrated in FIG. 6C.

FIG. 6C illustrates a VIPM implemented flow diagram detailing a breach detection process for a rack enclosure proximity detection system. Once a VIPM has a calibrated, corrected, and validated baseline image segments as illustrated in FIGS. 6A and 6B, the system is commissioned and enters the image breach detection phase. Within the detection phase, characteristics of an operational image segment of the boundary marker is evaluated against one or more characteristics of the established baseline image segments. This evaluation may include factors such as the environment, camera gain, and/or camera exposure. Embodiments of this disclosure contemplate autonomous adjustments to allow adaptation to the environment. It should be appreciated this evaluation may be accomplished on a complete image by complete image basis, image segment by image segment basis, pixel by pixel basis, and/or contour by contour basis.

An evaluation metric is determined 670 whether to trigger an alarm and/or event based on a metric calculated from one or more features and/or characteristics of the operational image segment. Principles of the disclosure contemplate evaluation of metrics such as average hue, number of pixels outside of an acceptable hue range, and/or other image or combination of image characteristics to evaluate an image. Embodiments of the disclosure utilize these evaluation metrics to reduce and/or eliminate false positive and/or false negative triggering of alarms and/or events.

Once the evaluation metric on an image by image, segment by segment, pixel by pixel, and/or contour by contour basis is determined 670, an evaluation of the characteristics of the corrected baseline image segments against the characteristics of the operational image segments 675 is processed. This comparison may be performed on an image by image, segment by segment, pixel by pixel, and/or contour by contour basis It should be appreciated a pre-evaluation state may also occur where various filtering or processing of several images and/or image segments prior to applying the evaluation metric. This pre-processing may be utilized to assure robust image and/or image segment capture to avoid, for example, false positive, and/or false negative detection triggering. While part of the evaluation of the baseline against the operational image segment(s) 675, such a process may utilize methods not utilized during the actual evaluation.

During the evaluation, itself, the evaluation metric determined 670 is compared to a threshold metric for each segmented image derived during the tessellation and/or segmentation process illustrated in FIGS. 4A-F. It should be appreciated a threshold metric may be created for the boundary image as a whole, where there is a single threshold. Further, individual image segments may themselves have independent thresholds. A combination is also contemplated where some image segments may share a threshold value where others remain independent of any other. Embodiments of the system contemplate an autonomous determination of threshold based on the baseline image characteristics, operational image segment characteristics, environment, and/or other facts which impact image processing.

Alternate embodiments contemplate utilizing a number of image segments or adjacent image segments as a feature to be utilized to determine an alert threshold. Further, a number of consecutive operational images where the boundary has appeared to have been breached may be utilized to determine an alert threshold.

It should be appreciated the image capture of the operational image segments may utilize various settings within the camera system. As detailed previously, due to the ability of embodiments of the system to create simpler image processing a wide range of acceptable camera settings are possible in various embodiments. As one of many examples, to accomplish robust detection from a baseline, a commercial off the shelf camera may be utilized at a framerate of 30 frames per second and an image size of 640×400 pixels. Other frame rates and image resolutions are contemplated as part of this disclosure.

Further, cameras with higher capabilities may be used, but may not be necessary in various embodiments. Principles of the disclosure contemplate the use of multiple lower capability cameras, in substitute of a single higher capability camera. In this way, further cost reduction is possible with the replacement of very high cost cameras and associated optics with no sacrifice of robust image detection.

A baseline image segment may be dynamic in nature and may be adaptable vary based on environmental conditions such as lighting, movement, and/or other conditions that may cause an image or image segment to change over time. It is beneficial to determine if the baseline image or image segment requires recalibration 680. Examples of when a recalibration may be beneficial may include if a predetermined period of time has passed since the last calibration, lighting conditions have deviated by a predetermined amount, and/or other cause as determined by a user and/or the system. If it is determined recalibration will occur processing transitions to the calibration flow 640 as illustrated in FIG. 6A.

If no recalibration will occur, a decision is made if there are changes to the baseline image or image segment 685. If no changes to the baseline, no action is taken and the system continues to evaluate the baseline image characteristics against the operational image or image segment characteristics 675. If, however the operational boundary differs from the baseline, which should result in a trigger, the system may communicate the changes to a management device 690, user, or other system to remediate the matter further.

Once this communication to a management device 690 occurs, the system continues to evaluate the baseline image or image segment characteristics against the operational image characteristics 675 until such time a user or the system determines another logic flow.

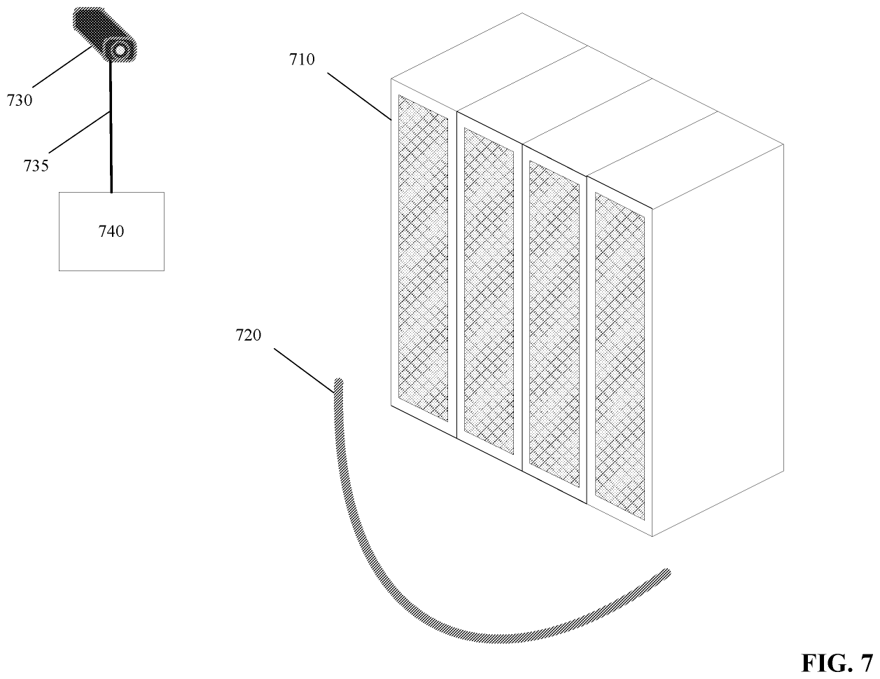

FIG. 7 illustrates examples of a rack enclosure proximity detection system comprising a single camera and boundary and boundary marker in accordance with various embodiments of this disclosure. Embodiments of a system may include a plurality of rack enclosures 710, a boundary marker 720, a camera 730, a computer system to process the video images produced by the camera 730, and a Video Image Processing Module (VIPM) 740, connected by a data and/or power connection 735, such as Power Over Ethernet (POE) or other data only standard, wired or wireless in nature.

As one of many embodiments, a boundary marker 720 is placed in front of the plurality of rack enclosures 710, a camera 730 will create a baseline image or image segment utilizing embodiments of the process illustrated in FIG. 6A-C. Once both calibration and correction of the baseline image or image segments are completed, the system will be ready to alert one or more users and/or take autonomous action if a detection occurs from a deviation between the established baseline and operational images or image segments.

In operation, for example, once a system for rack enclosure proximity detection is calibrated and corrected to detect any deviation from the established baseline, if any object were to pass into the frame of the camera 730 and onto the boundary marker 720, a series of events could be commenced to both alert security of an authorized entry and act to cease any further intrusion or prevent further access to the computer equipment located in the plurality of rack enclosures 710. Such activity may fall into alerting and/or preventing further access as well as identifying the existing intrusion.

Alerting regarding the intrusion may take on many forms that include, but are not limited to autonomously flashing a beacon on a rack or room to alert personnel of an intrusion. Audible indicators such as sirens or loud speaker announcements may also be used. Existing management systems may be utilized to contact appropriate personnel via voice message, text, email, and/or any other appropriate means, utilizing any established priority of users or delegation of authority.

Intrusion limiting activities may include, locking any rack enclosures not currently locked to prevent any further intrusions. Further, if any room doors are unlocked or other access control vestibule devices in use, they may be disabled/enabled to retain any intrusion to a particular area. Other autonomous activities may include stopping all data transfer to and/or from the rack enclosure that may be compromised or some and/or all data to a particular facility or part of the building. In this way, if a rack enclosure was accessed to deliver a malicious data payload, it would not be allowed to transmit to other machines.

Regarding identification, cameras may be trained onto the intrusion site and autonomously commanded to increase their frame rates to maximum in an attempt to capture all details possible. If other cameras are able to be trained onto the intrusion site, a command to any adjustable (Pan-Tilt-Zoom) camera may be utilized to not only obtain as much visual evidence as possible, but also track the intrusion if it were to move. In this way, an accurate reporting of where an intrusion source is may be collected and given to the appropriate authorities.

It should be appreciated the above scenario is exemplary only and many such schemes are possible utilizing the autonomous alerting and/or actions within a system for rack enclosure proximity detection.

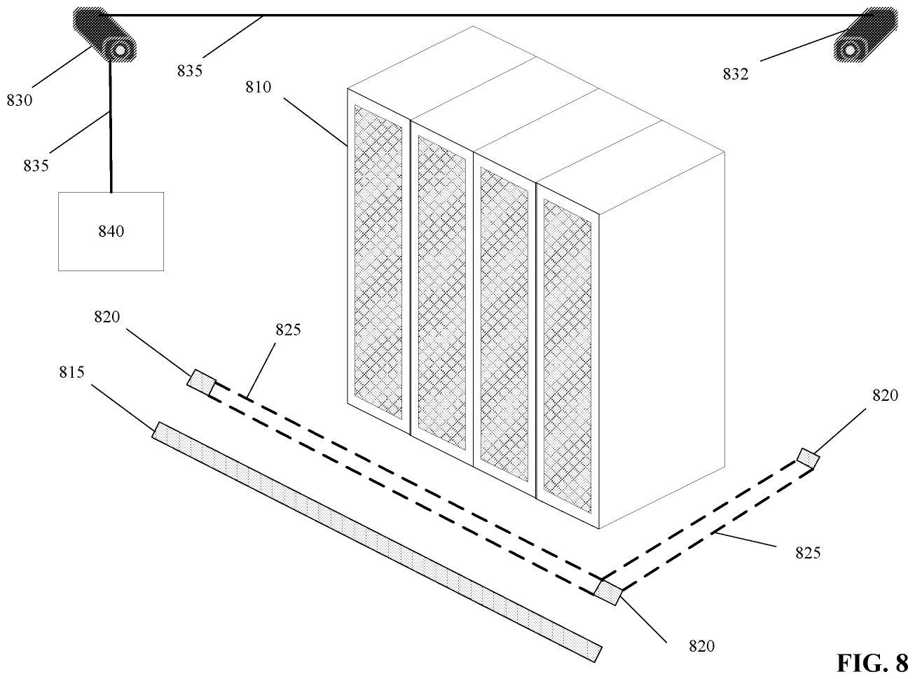

FIG. 8 illustrates alternate embodiments of a rack enclosure proximity detection system comprising a plurality of cameras and boundary markers in accordance with various embodiments of this disclosure. Embodiments of a system may include a plurality of rack enclosures 810, a visible boundary marker 815, a plurality of boundary marker index points 820, a plurality of cameras 830, 832, and a Video Image Processing Module (VIPM) 840, connected by a data and/or power connection 835, such as Power Over Ethernet (POE) or other data only standard, wired or wireless in nature.

Embodiments of the system contemplate a combination of visible and invisible boundary markers which may correlate to security levels. It should be appreciated a boundary marker need not be continuous in nature as illustrated in FIG. 7. Only a plurality of boundary marker index points 820 may be necessary to allow the VIPM 840 to extrapolate a virtual boundary marker between boundary marker index points 820.

Such an embodiment will require commissioning specific to the embodiment as illustrated in FIG. 6A-C. Both a visible boundary marker 815, 820 calibration and non-visible boundary marker calibration 825 will occur where the system will determine a baseline image and/or image segments. Once the calibration and commissioning are completed, the system will enter the detection phase to determine a breach to the visible and non-visible boundary markers.

It should be appreciated that one or more camera may be used in a rack enclosure proximity detection system. These cameras may operate independent of each other such as maintaining a single field of view, and/or in collaboration with another camera should a boundary marker require more than one camera to capture the entire boundary, and/or to provide a level of redundancy.

General purpose computer components may be used and configured as components of a rack enclosure proximity detection system. Such computer systems may be used in various embodiments of this disclosure, for example, general-purpose computers such as those based on Intel PENTIUM-type processor, Motorola PowerPC, Sun UltraSPARC, Hewlett-Packard PA-RISC processors, or any other type of processor.

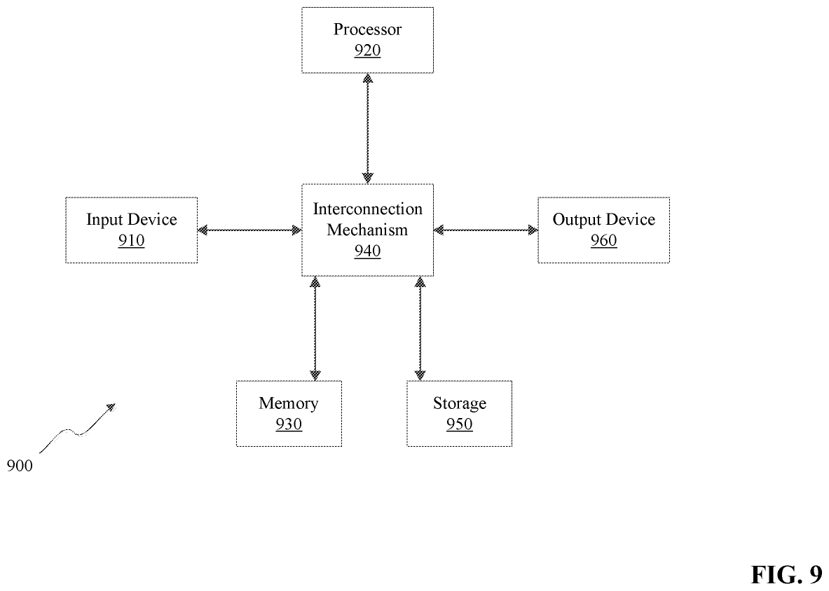

For example, various embodiments of the rack enclosure proximity detection system may utilize or be implemented utilizing specialized software executing in computer system components 900 such as that shown in FIG. 9. Embodiments of this computer system components 900 may be general-purpose in nature. The computer system components 900 may include a processor 920 connected to one or more memory devices 930, such as a disk drive, memory, or other device for storing data. Memory 930 is typically used for storing programs and data during operation of the computer system components 900. The computer system components 900 may also include a storage system 950 that provides additional storage capacity. Components of computer system 900 may be coupled by an interconnection mechanism 940, which may include one or more busses (e.g., between components that are integrated within the same machine) and/or a network (e.g., between components that reside on separate discrete machines). The interconnection mechanism 940 enables communications (e.g., data, instructions) to be exchanged between computer system components 900.

Computer system components 900 also includes one or more input devices 910, for example, a keyboard, mouse, trackball, microphone, touch screen, and one or more output devices 960, for example, a printing device, display screen, speaker. In addition, computer system 900 may contain one or more interfaces (not shown) that connect computer system 900 to a communication network (in addition or as an alternative to the interconnection mechanism 940).

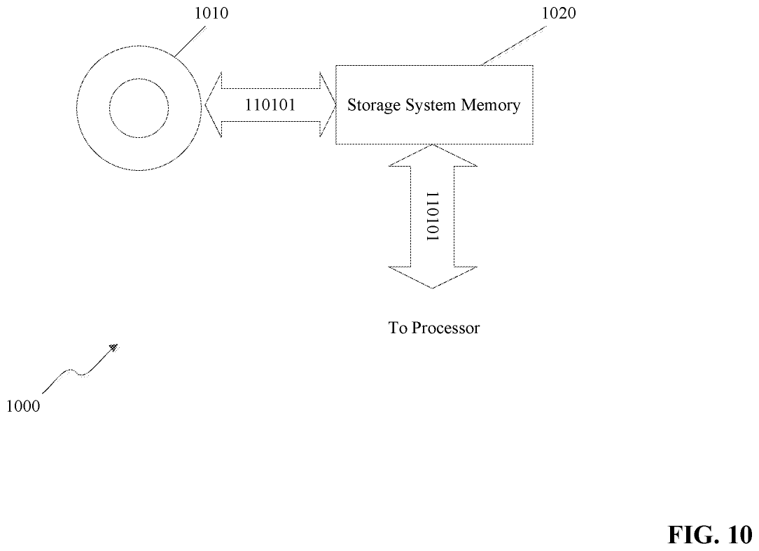

The storage system 950, shown in greater detail in FIG. 10, typically includes a computer readable and writeable nonvolatile recording medium 1010 in which signals are stored that define a program to be executed by the processor or information stored on or in the medium 1010 to be processed by the program to perform one or more functions associated with embodiments described herein. The medium may, for example, be a disk or flash memory. Typically, in operation, the processor causes data to be read from the nonvolatile recording medium 1010 into another memory 1020 that allows for faster access to the information by the processor than does the medium 1010. This memory 1020 is typically a volatile, random access memory such as a dynamic random access memory (DRAM) or static memory (SRAM). It may be located in storage system 1000, as shown, or in memory system 930. The processor 920 generally manipulates the data within the integrated circuit memory 930, 1020 and then copies the data to the medium 1010 after processing is completed. A variety of mechanisms are known for managing data movement between the medium 1010 and the integrated circuit memory element 930, 1020, and the disclosure is not limited thereto. The disclosure is not limited to a particular memory system 930 or storage system 950.

The computer system may include specially-programmed, special-purpose hardware, for example, an Application Specific Integrated Circuit (ASIC). Aspects of the disclosure may be implemented in software, hardware or firmware, or any combination thereof. Further, such methods, acts, systems, system elements and components thereof may be implemented as part of the computer system described above or as an independent component.

Although computer system 900 is shown by way of example as one type of computer system upon which various aspects of the disclosure may be practiced, it should be appreciated that aspects of the disclosure are not limited to being implemented on the computer system as shown in FIG. 10. Various aspects of the disclosure may be practiced on one or more computers having a different architecture or components shown in FIG. 10. Further, where functions or processes of embodiments of the disclosure are described herein (or in the claims) as being performed on a processor or controller, such description is intended to include systems that use more than one processor or controller to perform the functions.

Computer system 900 may be a general-purpose computer system that is programmable using a high-level computer programming language. Computer system 900 may be also implemented using specially programmed, special purpose hardware. In computer system 900, processor 920 is typically a commercially available processor such as the well-known Pentium class processor available from the Intel Corporation. Many other processors are available. Such a processor usually executes an operating system which may be, for example, the Windows 95, Windows 98, Windows NT, Windows 2000, Windows ME), Windows XP, Vista, or Windows 7, or progeny operating systems available from the Microsoft Corporation, MAC OS System X, or progeny operating system available from Apple Computer, the Solaris operating system available from Sun Microsystems, UNIX, Linux (any distribution), or progeny operating systems available from various sources. Many other operating systems may be used.

The processor and operating system together define a computer platform for which application programs in high-level programming languages are written. It should be understood that embodiments of the disclosure are not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., In Line) or interpreted (e.g., Java) code which communicate over a communication network (e.g., the Internet) using a communication protocol (e.g., TCP/IP). For example, one or more database servers may be used to store device data, such as expected power draw, that is used in designing layouts associated with embodiments of the present disclosure.

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as SmallTalk, Java, C++, Ada, or C# (C-Sharp). Other object-oriented programming languages may also be used. Alternatively, functional, scripting, and/or logical programming languages may be used, such as BASIC, ForTran, COBoL, TCL, or Lua. Various aspects of the disclosure may be implemented in a non-programmed environment (e.g., documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

Embodiments of a systems and methods described above are generally described for use in relatively large data centers having numerous equipment racks; however, embodiments of the disclosure may also be used with smaller data centers and with facilities other than data centers. Some embodiments may also be a very small number of computers distributed geographically so as to not resemble a particular architecture.

In embodiments of the present disclosure discussed above, results of analyses are described as being provided in real-time. As understood by those skilled in the art, the use of the term real-time is not meant to suggest that the results are available immediately, but rather, are available quickly giving a designer the ability to try a number of different designs over a short period of time, such as a matter of minutes.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A system of detecting proximity to a rack enclosure, comprising:
a processor configured to
extract a boundary mask image from a captured image,
perform image correction operations on the boundary mask image,
process the boundary mask image utilizing image processing operations to determine a corrected boundary mask image,
determine a mesh of image segments based on the corrected boundary mask image,
establish one or more baseline image metrics of the mesh image segments,
evaluate the one or more baseline image metrics for changes with operational image segment characteristics, and
communicate any baseline image metric changes to a management device.

2. The system of claim 1, wherein the corrected boundary mask image is processed to form a regular tessellation.

3. The system of claim 1, wherein the corrected boundary mask image is processed to form a semi-regular tessellation.

4. The system of claim 1, wherein the corrected boundary mask image is processed to form a demi-regular tessellation.

5. The system of claim 1, wherein the corrected boundary mask image is processed to form a segmented image.

6. The system of claim 1, wherein a boundary marker is dynamically shifted in time.

7. The system of claim 1, wherein a boundary marker comprises one of adhesive tape, infra-red reflective tape, paint, or laser markers.

8. The system of claim 1, wherein a boundary marker comprises removable objects.

9. A system of detecting proximity to a rack enclosure, comprising:
a rack enclosure;
a visible boundary marker;
a video camera configured to capture and transmit image data;
a Video Image Processing Module (VIPM) configured to receive and process image data from the video camera and communicate image data changes; and
a management device configured to receive image data changes.

10. The system of claim 9, further comprising a plurality of rack enclosures.

11. The system of claim 9, further comprising a plurality of boundary markers.

12. The system of claim 9, further comprising a plurality of video cameras.

13. The system of claim 9, further comprising a plurality of VIPMs.

14. A method of detecting proximity to a rack enclosure, comprising:
extracting, a boundary mask image from a captured image;
performing, image correction operations on the boundary mask image;
processing, the boundary mask image utilizing image processing operations to determine a corrected boundary mask image;
determining, a mesh of image segments based on the corrected boundary mask image;
establishing, one or more baseline image metrics of the mesh of image segments;
evaluating, the one or more baseline image metrics for changes with operational image segment characteristics; and
communicating, any baseline image metric changes to a management device.

15. The method of claim 1, wherein the corrected boundary mask image is processed to form a regular tessellation.

16. The method of claim 1, wherein the corrected boundary mask image is processed to form a semi-regular tessellation.

17. The method of claim 1, wherein the corrected boundary mask image is processed to form a demi-regular tessellation.

18. The method of claim 1, wherein the corrected boundary mask image is processed to form a segmented image.

19. The method of claim 1, wherein a boundary marker is dynamically shifted in time.

20. The system of claim 1, wherein a boundary marker comprises one of adhesive tape, infra-red reflective tape, paint, or laser markers.

21. The method of claim 1, wherein a boundary marker comprises removable objects.
